(19) United States
(12) Patent Application Publication
(10) Pub. No.: US 2008/0070516 A1
(43) Pub. Date: Mar. 20, 2008

(54) Audio data streaming with auto switching between wireless headset and speakers

(75) Inventors: Barry J. Lee, Santa Cruz, CA (US); James F. Bobisuthi, Boulder Creek, CA (US); Edward O. Sanderson, Santa Cruz, CA (US)

Correspondence Address: PLANTRONICS, INC., 345 ENCINAL STREET, P.O. BOX 635, SANTA CRUZ, CA, 95060-0635, US

(73) Assignee: Plantronics, Inc.

(21) Appl. No.: 11/522,200

(22) Filed: Sep. 15, 2006

(51) Int. Cl. H04B 1/38

(52) U.S. Cl. 455/90.1

(57) ABSTRACT

Systems and methods for a speaker system are disclosed. The speaker system generally includes an audio amplifier, a loudspeaker, a wireless communications module, and an electronic switch. The electronic switch receives an audio signal from an audio source and routes the audio signal to the audio amplifier or the wireless communications module. The electronic switch routes the audio signal to the wireless communications module upon formation of a wireless link by the wireless communications module.

### BACKGROUND OF THE INVENTION

Audio devices often allow a user to listen to an output audio signal such as music through a loudspeaker or through headphones. For example, a user may listen to music from a personal computer (PC) or other electronic device through externally powered loudspeakers, which are connected to the PC or electronic device and receive and output the audio signal. Alternatively, a user may wish to listen to the audio signal (also referred to herein as an audio stream) from the PC or electronic device using headphones or a communications headset. In the prior art, users must manually switch the audio signal between the speakers and the headset or vice versa. Manually switching the audio signal may be inconvenient or troublesome for the user.

As a result, there is a need for improved methods and apparatuses for switching between speakers and headsets.

### BRIEF DESCRIPTION OF THE DRAWINGS

The present invention will be readily understood by the following detailed description in conjunction with the accompanying drawings, wherein like reference numerals designate like structural elements.

FIG. 1 illustrates a simplified block diagram view of a speaker system in one example of the invention.

FIG. 2 illustrates a simplified block diagram of a wireless headset for use in one example of the invention.

FIGS. 3A and 3B are a flow chart illustrating operation of the speaker system in one example of the invention in which a wireless headset is undocked.

FIG. 4 is a flow chart illustrating operation of the speaker system in one example of the invention in which a wireless headset is docked.

FIG. 5 illustrates a simplified block diagram view of a speaker system in a further example of the invention.

FIGS. 6A and 6B are a flow chart illustrating operation of the speaker system shown in FIG. 5 in which a wireless headset is undocked.

FIG. 7 is a flow chart illustrating operation of the speaker system shown in FIG. 5 in which a wireless headset is docked.

FIG. 8 illustrates a simplified block diagram view of a speaker system in a further example of the invention.

### DESCRIPTION OF SPECIFIC EMBODIMENTS

Methods and apparatuses for speaker systems and wireless headsets are disclosed. The following description is presented to enable any person skilled in the art to make and use the invention. Descriptions of specific embodiments and applications are provided only as examples and various modifications will be readily apparent to those skilled in the art. The general principles defined herein may be applied to other embodiments and applications without departing from the spirit and scope of the invention. Thus, the present invention is to be accorded the widest scope encompassing numerous alternatives, modifications and equivalents consistent with the principles and features disclosed herein. For purpose of clarity, details relating to technical material that is known in the technical fields related to the invention have not been described in detail so as not to unnecessarily obscure the present invention.

Generally, this description describes a method and apparatus for a speaker system for outputting an audio stream which provides automated redirection of the audio stream from the speaker system loudspeaker or loudspeakers (also referred to herein as “speakers”) to a wireless headset and vice versa. The act of switching on or off the headset redirects the audio stream such that further manual intervention is not required.

In one example of the invention, a Bluetooth module with a redirect switch is embedded in a self powered speaker system. The Bluetooth module when not linked to a wireless Bluetooth headset passes the audio stream to the speaker system loudspeakers.

When the wireless Bluetooth headset is switched on and a Bluetooth wireless link is activated, the Bluetooth module in the speaker system automatically routes the audio stream to the wireless Bluetooth headset and mutes the loudspeakers. Similarly, when the headset Bluetooth link is terminated, the speaker system automatically routes the audio stream to the loudspeakers at the powered speaker system.

The present invention is applicable to a variety of different types of wireless listening devices in addition to mobile communication headsets, including stereo listening headsets (also referred to has headphones). While the present invention is not necessarily limited to such devices, various aspects of the invention may be appreciated through a discussion of various examples using this context.

In one example of the invention, a speaker system includes an audio amplifier, a loudspeaker, a wireless communications module, and an electronic switch. The electronic switch receives an audio signal from an audio source and routes the audio signal to the audio amplifier or the wireless communications module. The switch routes the audio signal to the wireless communications module upon formation of a wireless link by the wireless communications module.

In a further example of the invention, an audio system includes an audio source device and a loudspeaker system. The audio source device includes a first wireless communications module. The loudspeaker system includes an audio amplifier, a loudspeaker for receiving an amplified audio signal from the audio amplifier, and a second wireless communications module. The second wireless communications module receives an audio signal from the first wireless communications module over a first wireless link. The second wireless communication module includes a switch for routing the audio signal to the loudspeaker system audio amplifier or transmitting the audio signal over a second wireless link to a wireless headset upon activation of the wireless headset.

In an example of the invention, a method for automatically routing an audio signal is presented. The method includes providing a speaker system having a loudspeaker, a first wireless communications module, and an electronic switch. A wireless headset includes a second wireless communications module and a headset speaker. The method includes receiving an audio signal at the speaker system from an audio source device and automatically setting the electronic switch to a first position to route the audio signal to the loudspeaker or to a second position to route the audio signal to the first wireless communications module. The electronic switch is set to the second position upon activation of the wireless headset and formation of a wireless link between the first wireless communications module and the second wireless communications module. The electronic switch is set to the first position upon deactivation of the wireless headset and termination of the wireless link.

In an example of the invention, a further method for automatically routing an audio signal is presented. The method includes providing a speaker system including a loudspeaker, a first wireless communications module, and an electronic switch. A wireless headset includes a second wireless communications module and a headset speaker. The method includes receiving an audio signal at the speaker system from an audio source device, setting the electronic switch to route the audio signal to the loudspeaker. The method further includes activating the wireless headset and establishing a wireless link between the first wireless communications module and the second wireless communications module. The method further includes responsively setting the electronic switch to route the audio signal to the first wireless communications module and transmitting the audio signal from the first wireless communications module to the second wireless communications module over the wireless link. The audio signal is output at the headset speaker.

In a further example of the invention, an audio system includes an audio source device, a loudspeaker system, and a wireless headset. The audio source device includes a first wireless communications module and a switch for routing an audio signal. The loudspeaker system includes an audio amplifier, a loudspeaker for receiving an amplified audio signal from the audio amplifier, and a second wireless communications module for receiving the audio signal from the first wireless communications module over a first wireless link. The wireless headset includes a headset speaker and a third wireless communications module for receiving the audio signal from the first wireless communications module over a second wireless link. The switch routes the audio signal to the wireless headset upon activation of the wireless headset and the switch routes the audio signal to the loudspeaker system upon deactivation of the wireless headset.

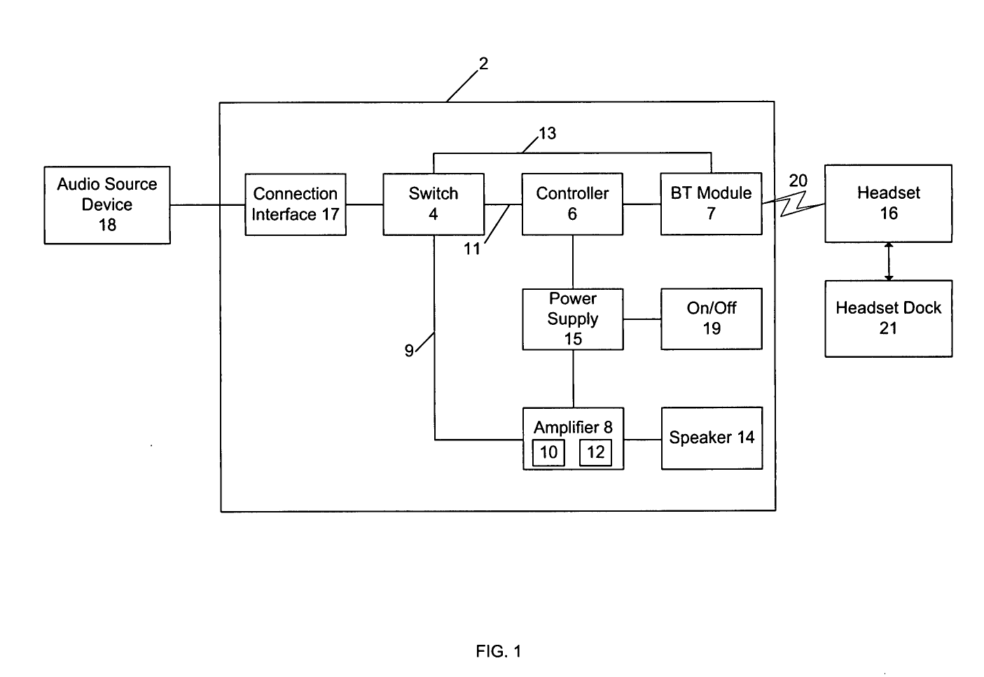

FIG. 1 illustrates a simplified block diagram view of a speaker system 2 in one example of the invention. An audio source device 18 provides audio to speaker system 2. For example, audio source device 18 may be a computer system including a CPU, storage, memory, and a host interface for outputting digital audio to speaker system 2. For example, audio source device 18 may be coupled via a mini-phone stereo 3.5 mm connector or USB cable to speaker system 2.

The speaker system 2 receives audio signals at a connection interface 17, which provides the audio signals to a switch 4 controlled by controller 6. In one state of operation, controller 6 operates switch 4 to provide the audio signals along line 9 to amplifier 8. Controller 6 operates switch 4 using a switch control signal along line 11. Amplifier 8 drives loudspeaker 14. Although only a single amplifier 8 and loudspeaker 14 are illustrated in FIG. 1, speaker system 2 may include additional amplifiers or loudspeakers for multiple channels of audio signals. In such an example, a decoder is utilized to identify the audio signal channel for each amplifier and loudspeaker. Amplifier 8 may include a pre-amplifier stage circuit 10 and a power amplifier stage circuit 12 using an operational amplifier designed for high quality audio performance. Controller 6 may further provide an amplifier control signal to amplifier 8. Controller 6 may for example be an integrated circuit. Power supply 15 supplies power to the amplifier 8 and other components of speaker system 2, and may be turned on by a power on/off switch 19. In one example, speaker system 2 is self powered by a power supply 15 driven by a conventional 120V AC wall electrical outlet to provide DC power to the components of speaker system 2. In a further example, power supply 15 is a battery or other power source.

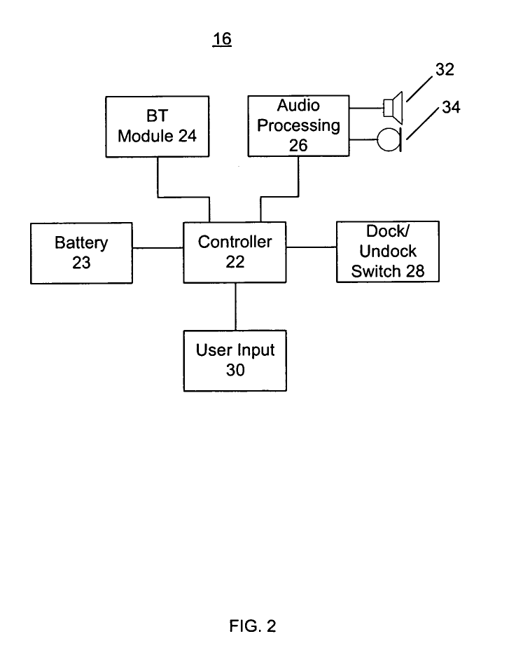

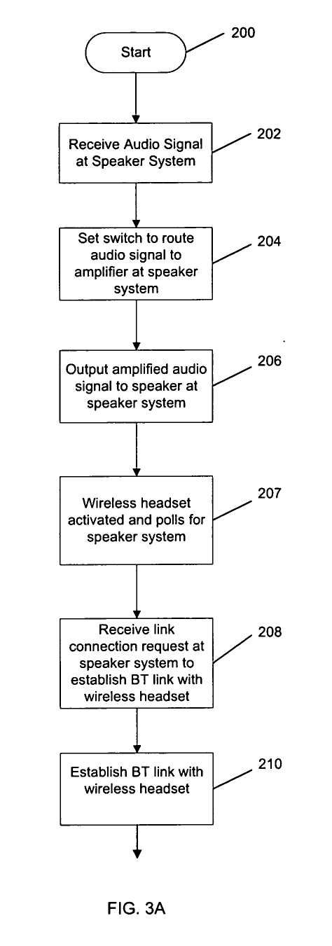

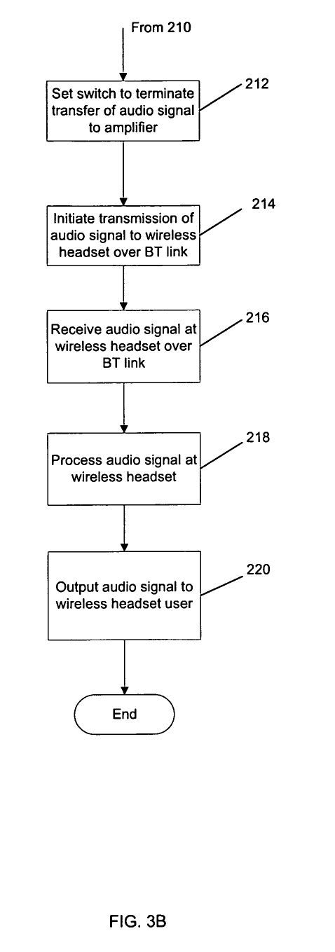

In a second state of operation, controller 6 operates switch 4 to provide the audio signals to a Bluetooth module 7 for wireless transmission from speaker system 2 to a proximate wireless headset 16 having Bluetooth functionality. The term “module” is used interchangeably with “circuitry” herein. For example, Bluetooth module 7 may be a chip module. Wireless headset 16 includes internal components which are described below in reference to FIG. 2. The controller 6 operation of switch 4 is triggered to route audio signals to Bluetooth module 7 along line 13 when controller 6 receives a control signal from Bluetooth module 7 that Bluetooth link 20 between wireless headset 16 and Bluetooth module 7 has been established. In one example of the invention, as described in further detail below in reference to FIG. 3, wireless headset 16 is activated and establishes Bluetooth link 20 with Bluetooth module 7 upon undocking of wireless headset 16 from headset docking station 21. Although illustrated separately, controller 6 and Bluetooth module 7 may be integrated onto a single chip module.

In one example of the invention, switch 4 is a software controlled switch. For example, switch 4 is a field effect transistor (FET). Additional examples of switch 4 include, without limitation, relays or microelectromechanical (MEMS) switches. When the headset 16 is docked with headset dock 21, the software executed by controller 6 activates the FET via a programmed input/output (PIO) on the controller 6. In an example where the controller is integrated with a Bluetooth module chip, the PIO is on the Bluetooth module chip. When the FET is activated, the audio stream is passed to amplifier 8 for output to loudspeaker 14. When the headset 16 is undocked i.e. in use, the software executed by controller 6 deactivates the FET by changing the state of the PIO, switching off the audio to the loudspeaker 14 and via the software transfers the audio stream to the Bluetooth module 7 for transmission over Bluetooth link 20. Controller 6 may receive a user input such as a switch to output the audio signal simultaneously at both loudspeaker 14 and headset 16.

The Bluetooth specification, version 2.0, is hereby incorporated by reference. A prescribed interface such as Host Control Interface (HCI) is defined between each Bluetooth module. Message packets associated with the HCI are communicated between the Bluetooth modules. Control commands, result information of the control commands, user data information, and other information are also communicated between Bluetooth modules.

In the examples described herein, speaker system 2 and wireless headset 16 communicate over a Bluetooth personal area network (PAN) via the wireless link established by the Bluetooth module 7 and a corresponding Bluetooth module at the wireless headset 16. In further examples of the invention, the PAN may use a variety of radio-frequency networks. For example, the radio-frequency network could employ 802.11, or DECT standards based communication protocols in place of Bluetooth.

FIG. 2 illustrates a simplified block diagram of a wireless headset 16 for use in one example of the invention. Referring to FIG. 2, components of a wireless headset 16 include a Bluetooth module 24, a headset controller 22, an audio processor 26, a dock/undock switch 28, one or more speakers 32, a microphone 34 and a user input 30. A battery 23 provides power to the wireless headset components. In a further example of the invention, the wireless headset may not have a microphone.

Headset controller 22 controls the overall operation of the wireless headset, and comprises a processor, memory and software to implement functionality as described herein. The headset controller 22 receives input from headset user input 30. Where the audio data is a stereo signal, audio processor 26 includes a stereo decoder and each audio channel is output to a different speaker 32. The headset controller 22 further interacts with Bluetooth module 24 to transmit and receive signals between the wireless headset 16 and speaker system 2. Bluetooth module 24 also includes an antenna. In a further example, the Bluetooth module 24 may include a controller which controls one or more operations of the wireless headset 16. Although the use of a Bluetooth module 24 is described in the present example, wireless headset 16 may use a wireless communication module implementing a variety of wireless communication technologies to correspond with the wireless communication technology employed by the speaker system. For example, wireless communication modules operating on the IEEE 802.11 or DECT standard may be used.

The Bluetooth module 24 enables the wireless headset to communicate with other Bluetooth devices according to the Bluetooth protocol. The Bluetooth modules transmit and receive a control command, a response thereto and user data by exchanging message packets through a host control interface (HCI) defined between the Bluetooth modules. An RS232 interface, a USB interface, or a standard PC interface can, for example, be utilized to actually transmit an HCI packet. The HCI packet is classified into a command packet, an event packet and a data packet. The command packet provides about 60 command words for various utilizations of the Bluetooth module. Under the control of the controller 22, the audio processor 26 demodulates an audio signal received from the Bluetooth module 24 into an audio signal and provides the demodulated audio signal to the speaker 32.

The user input 30 provides data or selections inputted by the user to the controller 22. The user input 30 may include a multifunction power, volume, mute, and select button or buttons. Other user interfaces may be included on the headset, such as a link active/end interface. It will be appreciated that numerous other configurations exist for the user interface, as the particular button or buttons and their locations are not critical to the present invention. The main housing of the headset may be in the shape of a loop to be worn behind a user's ear, may use a headband, or have another shape or wearing means. Controller 22 receives information from dock/undock switch 28 whether the headset is docked or undocked from a headset docking station and may responsively power on/off the headset upon docking or undocking.

FIGS. 3A and 3B are a flow chart illustrating operation of the speaker system in one example of the invention in which a user undocks a wireless headset. At start block 200, a headset is docked at a headset docking station. At block 202, the speaker system receives an audio signal from an audio source device. At block 204, a controller sets a switch so that the audio signal is routed to an amplifier at the speaker system. At block 206, the amplifier outputs an amplified audio signal to the speaker system loudspeakers. At block 207, the wireless headset is activated and polls for possible speaker systems. Activation and polling are performed in a manner similar to the Bluetooth Device Discovery Procedure as described in the Bluetooth Specification.

At block 208, the speaker system receives a link connection request from the wireless headset to establish a Bluetooth link. At block 210, the speaker system Bluetooth module establishes a wireless Bluetooth link with a wireless headset Bluetooth module. In one example, the Bluetooth link is automatically established when the wireless headset is undocked from the headset docking station. In a further example, the Bluetooth link is established when a user manually activates the wireless headset using a headset user interface.

Upon formation of the Bluetooth link, at block 212 the speaker system controller operates the switch to terminate transfer of the audio signal to the amplifier. At block 214, the controller initiates transmission of the audio signal over the Bluetooth link from the speaker system Bluetooth module to the wireless headset Bluetooth module. At block 216, the wireless headset Bluetooth module receives the audio signal over the wireless link. At block 218, the wireless headset processes the audio signal. At block 220, the audio signal is output to the user via the wireless headset speaker or speakers.

Formation of the Bluetooth link between the wireless headset and the speaker system upon a link connection request by a wireless headset will now be described. The headset controller determines whether the headset has been undocked or the user has activated the headset manually via a headset user interface. Upon this determination, the headset controller determines whether a speaker system Bluetooth module with which the wireless headset is registered is located within the coverage area where a Bluetooth link may be formed. If yes, the headset controller transmits a link connection request message to the powered stereo system Bluetooth module. If a link connection response message is received from the speaker system, the Bluetooth wireless link is formed between the wireless headset and the speaker system.

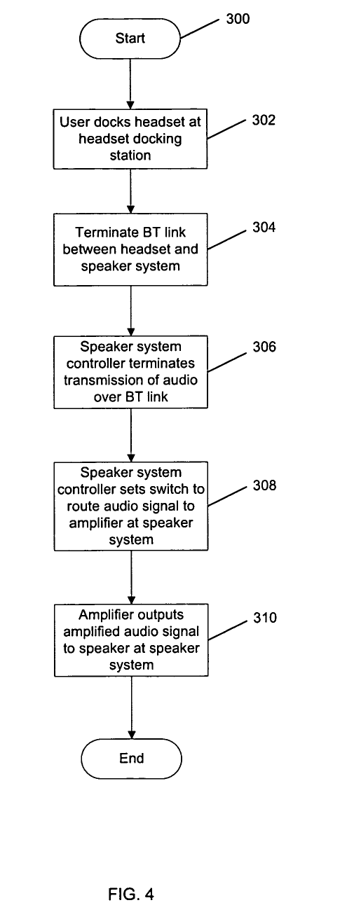

FIG. 4 is a flow chart illustrating operation of the speaker system in one example of the invention in which a user docks a wireless headset. At start block 300, a headset is receiving audio over the Bluetooth link with a speaker system. At block 302, a user docks the headset at a headset docking station. Alternatively, the user may manually turn off the headset. At block 304, the Bluetooth link between the headset and the speaker system is terminated. At block 306, the speaker system controller terminates transfer of audio to the speaker system Bluetooth module. At block 308, the speaker system controller sets a switch so that the audio signal is routed to an amplifier at the speaker system. At block 310, the amplifier outputs an amplified audio signal to the speaker system loudspeakers.

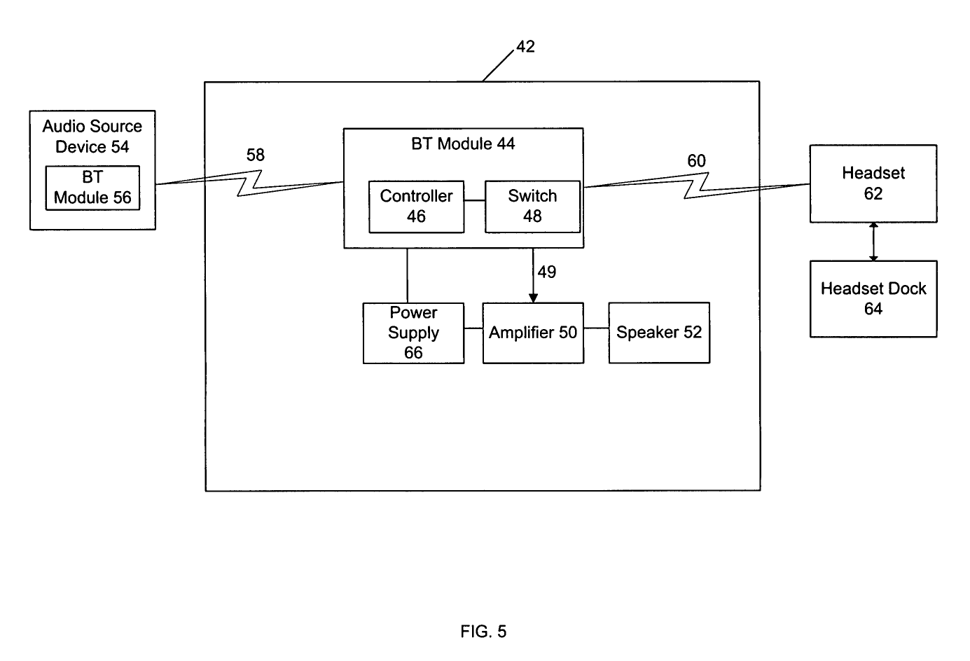

FIG. 5 illustrates a simplified block diagram view of a speaker system in a further example of the invention. An audio source device 54 provides audio to speaker system 42. For example, audio source device 54 may be a computer system including a CPU, storage, memory, and a host interface for outputting digital audio to speaker system 42. Audio source device 54 includes a Bluetooth module 56 for outputting digital audio to speaker system 42 over a Bluetooth link 58.

The speaker system 42 receives the audio signals over Bluetooth link 58 at a Bluetooth module 44. Bluetooth module 44 provides the audio signals to a switch 48 operated by controller 46. In one state of operation, controller 46 operates switch 48 to provide the audio signals along line 49 to amplifier 50. In one example of the invention, switch 48 is a software controlled switch. For example, switch 48 may be a field effect transistor that is turned on or off as desired to route the audio signal. Additional examples of switch 48 include, without limitation, relays or microelectromechanical (MEMS) switches. In additional examples, other types of switches capable of performing the same function may be used. Amplifier 50 drives one or more loudspeakers 52. Although only a single amplifier and loudspeaker 52 is illustrated, speaker system 42 may include additional amplifiers and corresponding loudspeakers for multiple channels of audio signals. In such an example, a decoder is utilized to identify the audio signal channel for each amplifier and loudspeaker. Amplifier 50 may include a pre-amplifier stage circuit and a power amplifier stage circuit using an operational amplifier designed for high quality audio performance. Controller 46 may, for example, be an integrated circuit. Power supply 66 supplies power to the amplifier 50 and other components of speaker system 42, and may be turned on by a power on/off switch. In one example, speaker system 42 is a self-powered and power supply 66 is driven by a conventional 120V AC wall electrical outlet to provide DC power to the components of speaker system 42. In a further example, power supply 15 is a battery, allowing speaker system 42 to be a wireless device.

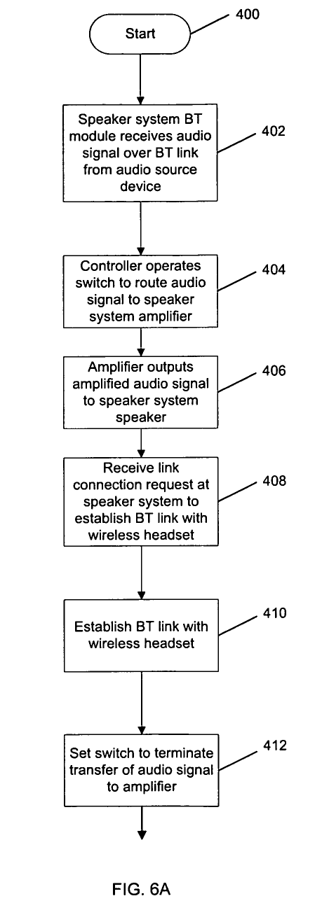

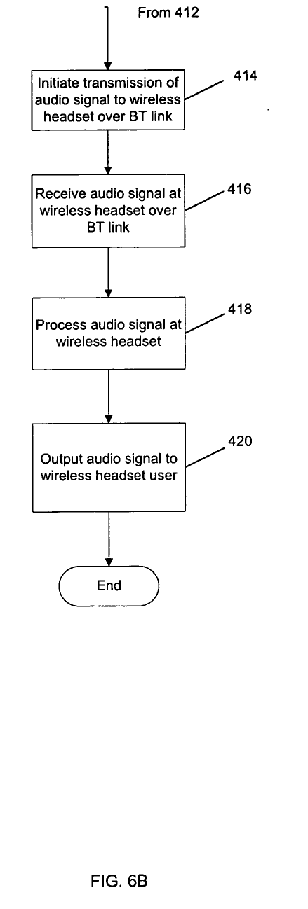

In a second state of operation, controller 46 operates switch 48 within Bluetooth module 44 to transmit the audio signals over a Bluetooth link 60 from speaker system 42 to a wireless headset 62. In one example, the Bluetooth module 44 receives digital audio signals and retransmits the digital audio signals over Bluetooth link 60. In a further example, Bluetooth module 44 receives digital audio signals, converts the signal to an analog signal, and then reconverts the signal to a digital signal for transmission over Bluetooth link 60. The controller 46 operation of switch 48 is triggered to route audio signals over Bluetooth link 60 when controller 46 receives a control signal that Bluetooth link 60 between wireless headset 62 and Bluetooth module 44 has been established. In one example of the invention, as described in further detail below in reference to FIG. 6, wireless headset 62 establishes Bluetooth link 60 with Bluetooth module 44 upon undocking of wireless headset 62 from a headset docking station 64. Controller 46 may receive a user input such as a switch to output the audio signal simultaneously from both loudspeaker 52 and headset 62.

In the example shown in FIG. 5, wireless speaker system 42 may be flexibly placed without the need for connecting wires. Speaker system 42 may be battery powered, further increasing placement flexibility. The further use of a wireless headset 62 provides additional listening flexibility.

FIGS. 6A and 6B are a flow chart illustrating operation of the speaker system shown in FIG. 5 in which a wireless headset is undocked. At start block 400, a headset is docked at a headset docking station. At block 402, a speaker system Bluetooth module receives an audio signal from an audio source device over a Bluetooth link. At block 404, a controller sets a switch so that the audio signal is routed to an amplifier at the speaker system. At block 406, the amplifier outputs an amplified audio signal to the speaker system loudspeakers. At block 408, the speaker system receives a link connection request from the wireless headset. At block 410, a speaker system Bluetooth module establishes a wireless Bluetooth link with a wireless headset Bluetooth module. In one example, the Bluetooth link is established when the wireless headset is undocked from the headset docking station. In a further example, the Bluetooth link is established when a user manually activates the wireless headset using a headset user interface.

Upon formation of the Bluetooth link, at block 412 the speaker system controller operates the switch to terminate transfer of the audio signal to the amplifier. In one example of the invention, the controller is located within the Bluetooth module at the speaker system. At block 414, the controller initiates transmission of the audio signal over the Bluetooth link from the speaker system Bluetooth module to the wireless headset Bluetooth module. At block 416, the wireless headset Bluetooth module receives the audio signal over the wireless link. At block 418, the wireless headset processes the audio signal. At block 420, the audio signal is output to the user via the wireless headset speaker or speakers. Formation of the Bluetooth link between the wireless headset and the speaker system upon a request by a wireless headset is as described above. In this manner, the user does not need to manually switch the audio from the speaker system to the wireless headset as switching is performed automatically at the speaker system.

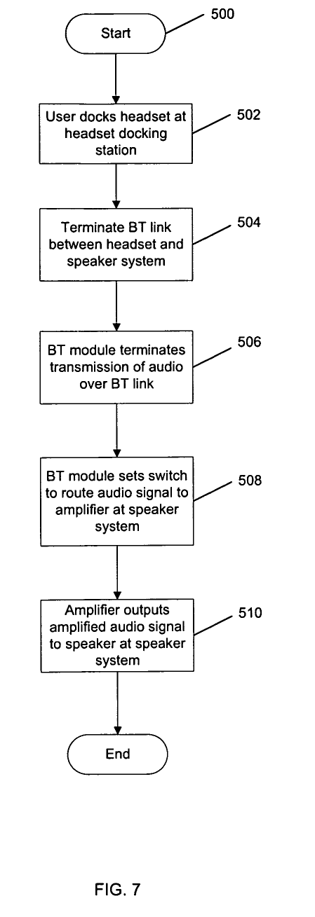

FIG. 7 is a flow chart illustrating operation of the speaker system shown in FIG. 5 in which a wireless headset is docked by a user. At start block 500, a wireless headset is receiving audio over the Bluetooth link with a speaker system. At block 502, a user docks the headset at a headset docking system. Alternatively, the user may manually turn off the headset. At block 504, the Bluetooth link between the headset and the speaker system is terminated. At block 506, the speaker system Bluetooth module stops routing of the audio signal over the Bluetooth link to the headset. At block 508, the speaker system Bluetooth module sets a switch so that the audio signal is routed to an amplifier at the speaker system. At block 510, the amplifier outputs an amplified audio signal to the speaker system loudspeakers.

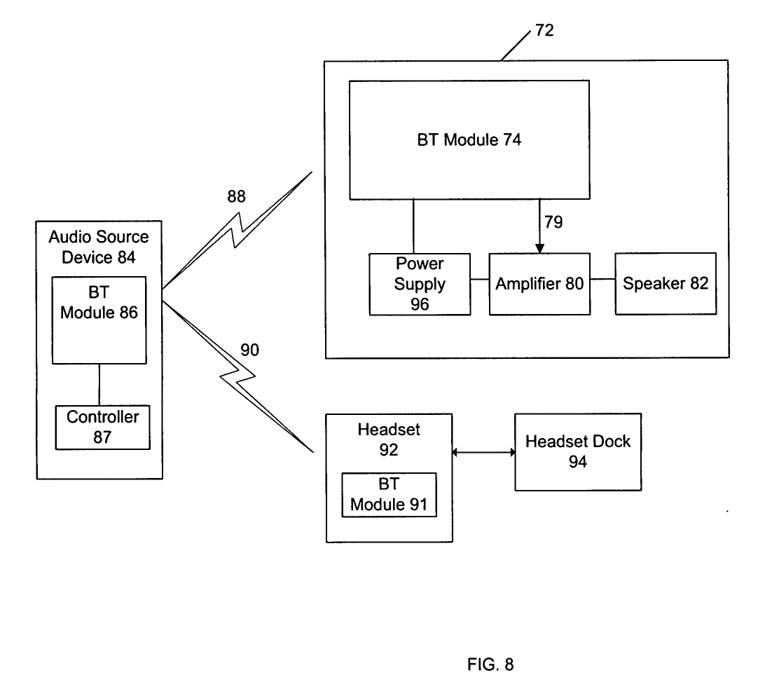

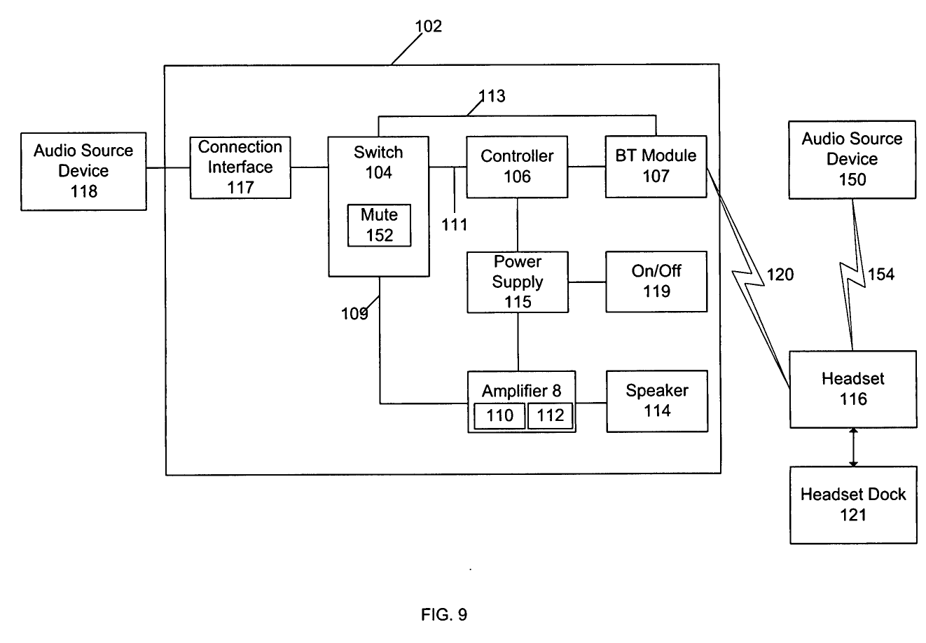

FIG. 8 illustrates a simplified block diagram view of a speaker system in a further example of the invention. An audio source device 84 provides audio to powered speaker system 72. For example, audio source device 84 may be a computer system including a CPU, storage, memory, and a host interface for outputting digital audio to powered speaker system 72. Audio source device 84 includes a Bluetooth module 86 for outputting digital audio to speaker system 72 over a Bluetooth link 88. Software at audio source device 84 selectively routes audio to either powered speaker system 72 (over Bluetooth link 88) or a headset 92 (over Bluetooth link 90).

The powered speaker system 72 receives the audio signals over Bluetooth link 88 at a Bluetooth module 74. Bluetooth module 74 provides the audio signals to a line 79 to amplifier 80. Amplifier 80 drives one or more loudspeakers 82. Although only a single amplifier and loudspeaker 82 is illustrated, powered speaker system 72 may include additional amplifiers and corresponding loudspeakers for multiple channels of audio signals. A decoder is utilized to identify the audio signal channel for each amplifier and loudspeaker. A power supply 96 supplies power to the amplifier 80 and other components of powered speaker system 72. In one example, power supply 96 is driven by a conventional 120V AC wall electrical outlet to provide DC power to the components of powered speaker system 72. In a further example, powered speaker system 72 receives power from a battery or other power source.

In a second state of operation, a controller 87 at audio source device 84 executes code to transmit the audio signals over a Bluetooth link 90 from audio source device 84 to a Bluetooth module 91 at wireless headset 92. The controller 87 routes audio signals over Bluetooth link 90 when controller 87 receives a control signal that Bluetooth link 90 between wireless headset 92 and Bluetooth module 86 has been established. In one example of the invention, wireless headset 92 establishes Bluetooth link 90 with Bluetooth module 86 upon undocking of wireless headset 92 from a headset docking station 94. Alternatively, Bluetooth link 90 may be established upon depression of an activation button on headset 92. In this manner, headset 92 is treated as the priority device by audio source device 84 whenever headset 92 is activated.

FIG. 9 illustrates a simplified block diagram view of a speaker system 102 in a further example of the invention. Speaker system 102 has the same functionality as speaker system 2 described above in reference to FIG. 1 and FIG. 3, with the added functionality of a mute switch upon receipt of a mute command from a headset 116. An audio source device 118 provides audio to speaker system 102. For example, audio source device 118 may be a computer system including a CPU, storage, memory, and a host interface for outputting digital audio to speaker system 102.

An audio source device 150 is configured to operate with a headset 116. For example, audio source device 150 may be a cellular phone, digital music player, or other electronic device. When audio source device 150 is active, wireless headset 116 is activated and establishes Bluetooth link 154 with a Bluetooth module at audio source device 150 upon undocking of wireless headset 116 from headset docking station 121. Bluetooth link 120 is also established with speaker system 102. For example, when audio source device 150 is active, wireless headset 116 considers audio source device 150 as the primary device when wireless headset 116 is activated. Upon activation, wireless headset 116 automatically sends a mute command to speaker system 102 over Bluetooth link 120. For example, the command may be either a proprietary command (over a serial profile for example) or using a secondary standard profile (such as the remote control profile) to send a mute command generated automatically when wireless headset 116 connects to audio source device 150. The command may be implemented with standard Bluetooth commands along with custom firmware in wireless headset 116. If speaker system 102 is currently outputting music at loudspeaker 114, controller 106 mutes the audio output using mute switch 152. In this manner, audio output by speaker system 102 is automatically muted upon activation of wireless headset 116. Multiple Bluetooth “profiles” can be set-up for each link between the wireless headset 116 and other devices. These profiles use the same radio link but define different data protocols. Multiple profiles can be active simultaneously over the same radio link between two devices. Proprietary profiles are also possible.

In the examples described herein, speaker system 102, wireless headset 116, and audio source device 150 communicate over a Bluetooth personal area network (PAN) via the Bluetooth links 120, 154. In further examples of the invention, the PAN may use a variety of radio-frequency networks. For example, the radio-frequency network could employ 802.11, or DECT standards based communication protocols in place of Bluetooth. Custom protocols and profiles may be used.

In a further example, speaker system 102 has four operational states. In the first state, headset 116 is inactive and loudspeaker 114 is on. In the second state, headset 116 is active and receiving streamed audio from speaker system 102, and loudspeaker 114 is off. In a third operational state, headset 116 is active and receiving audio from audio source device 150, while loudspeaker 114 is off (e.g., through muting). In a fourth operational state, wireless headset 116 is active and receiving and outputting streamed audio from speaker system 102, and loudspeaker 114 is on. Whether loudspeaker 114 is on providing dual output along with wireless headset 116 may be controlled by a user interface located at speaker system 102.

Furthermore, there may be a mute toggle button on the speaker system 102 to override the default behavior in case the radio link fails and the wireless headset 116 can't restore proper operation. For operational state one, the audio stream would be suspended and no mute would be have been generated so the speaker system 102 would be on. For operational state two there would be an active audio stream between the speaker system 102 and the wireless headset 116 so the speaker system 102 would be off (possibly overridden by toggling the speaker system 102 mute button to create operational state four). For operational state three, the wireless headset 116 suspends the stream from the speaker system 102 (normal behavior) and issue a mute command via a separate profile (new). The suspend is normal, the automatic mute (and the corresponding un-mute at the termination of an active link to another device) may be custom programmed but may also use a standard profile for command transmission.

The various examples described above are provided by way of illustration only and should not be construed to limit the invention. Based on the above discussion and illustrations, those skilled in the art will readily recognize that various modifications and changes may be made to the present invention without strictly following the exemplary embodiments and applications illustrated and described herein. Such changes may include, but are not necessarily limited to: power source of the speaker system, type of wireless headset, wireless communication technologies or protocols used to form the wireless links described herein, whether controller circuitry performing functions described herein is integrated with or separate from Bluetooth modules, and type of audio source device. Such modifications and changes do not depart from the true spirit and scope of the present invention that is set forth in the following claims.

While the exemplary embodiments of the present invention are described and illustrated herein, it will be appreciated that they are merely illustrative and that modifications can be made to these embodiments without departing from the spirit and scope of the invention. Thus, the scope of the invention is intended to be defined only in terms of the following claims as may be amended, with each claim being expressly incorporated into this Description of Specific Embodiments as an embodiment of the invention.

What is claimed is:

1. A speaker system comprising:
an audio amplifier;
a loudspeaker;
a wireless communications module; and
an electronic switch for receiving an audio signal from an audio source and routing the audio signal to the audio amplifier or the wireless communications module, wherein the electronic switch routes the audio signal to the wireless communications module upon formation of a wireless link by the wireless communications module.

2. The speaker system of claim 1, wherein the electronic switch comprises a field effect transistor, relay, or microelectromechanical switch.

3. The speaker system of claim 2, wherein the field effect transistor, relay, or microelectromechanical switch is controlled using a programmed input/output.

4. The speaker system of claim 1, wherein the wireless communications module utilizes a Bluetooth standard.

5. The speaker system of claim 1, wherein the wireless communications module utilizes an IEEE 802.11 or DECT standard.

6. The speaker system of claim 1, further comprising:
a wireless headset comprising a headset wireless communications module and a headset speaker, wherein the headset wireless communications module forms the wireless link upon activation of the wireless headset and receives the audio signal for output to the headset speaker.

7. The speaker system of claim 6, further comprising:
a headset docking station for receiving the wireless headset, wherein the wireless headset is automatically activated upon removal from the headset docking station and automatically deactivated when placed in the headset docking station.

8. An audio system comprising:
an audio source device comprising a first wireless communications module;
a loudspeaker system comprising
an audio amplifier;
a loudspeaker for receiving an amplified audio signal from the audio amplifier;
a second wireless communications module for receiving an audio signal from the first wireless communications module over a first wireless link, wherein the second wireless communications module comprises a switch for routing the audio signal to the audio amplifier or transmitting the audio signal over a second wireless link with a wireless headset upon activation of the wireless headset.

9. The audio system of claim 8, wherein the switch comprises a field effect transistor, relay, or microelectromechanical switch.

10. The audio system of claim 9, wherein the field effect transistor, relay, or microelectromechanical switch is controlled using a programmed input/output.

11. The audio system of claim 8, wherein the first wireless communications module, second wireless communications module, and third wireless communications module utilize a Bluetooth standard.

12. The audio system of claim 8, wherein the first wireless communications module, second wireless communications module, and third wireless communications module utilize an IEEE 802.11 or DECT standard.

13. The audio system of claim 8, further comprising:
a headset docking station for receiving the wireless headset, wherein the wireless headset is automatically activated upon removal from the headset docking station and automatically deactivated when placed in the headset docking station.

14. A method for automatically routing an audio signal comprising:
providing a speaker system comprising a loudspeaker, a first wireless communications module, and an electronic switch;
providing a wireless headset comprising a second wireless communications module and a headset speaker;
receiving an audio signal at the speaker system from an audio source device;
automatically setting the electronic switch to a first position to route the audio signal to the loudspeaker or to a second position to route the audio signal to the first wireless communications module, wherein the electronic switch is set to the second position upon activation of the wireless headset and formation of a wireless link between the first wireless communications module and the second wireless communications module and the electronic switch is set to the first position upon deactivation of the wireless headset and termination of the wireless link.

15. The method of claim 14, wherein the first wireless communications module and the second wireless communications module utilize a Bluetooth standard.

16. The method of claim 14, wherein the first wireless communications module and the second wireless communications module utilize an IEEE 802.11 standard or a DECT standard.

17. The method of claim 14, wherein the audio source device comprises a third wireless communications module and the audio signal is transmitted from the third wireless communications module to the first wireless communications module.

18. The method of claim 14, further comprising outputting the audio signal at the headset speaker when the electronic switch is set to the second position.

19. A method for automatically routing an audio signal comprising:
providing a speaker system comprising a loudspeaker, a first wireless communications module, and an electronic switch;
providing a wireless headset comprising a second wireless communications module and a headset speaker;
receiving an audio signal at the speaker system from an audio source device;
setting the electronic switch to route the audio signal to the loudspeaker;
activating the wireless headset and establishing a wireless link between the first wireless communications module and the second wireless communications module;
responsively setting the electronic switch to route the audio signal to the first wireless communications module; and
transmitting the audio signal from the first wireless communications module to the second wireless communications module over the wireless link; and
outputting the audio signal at the headset speaker.

20. The method of claim 19, wherein the first wireless communications module and the second wireless communications module utilize a Bluetooth standard.

21. The method of claim 19, wherein the first wireless communications module and the second wireless communications module utilize an IEEE 802.11 standard or a DECT standard.

22. The method of claim 19, wherein the audio source device comprises a third wireless communications module and the audio signal is transmitted from the third wireless communications module to the first wireless communications module.

23. A speaker system comprising:
an amplifier means for amplifying an audio signal;
a loudspeaker means for outputting the audio signal;
a wireless communications means for forming a wireless link; and
a switching means for routing the audio signal to the amplifier means or wireless communications means, wherein the switching means routes the audio signal to the wireless communications means upon formation of the wireless link.

24. The speaker system of claim 23, further comprising a wireless headset means for forming the wireless link with the wireless communications means and receiving the audio signal.

25. The speaker system of claim 24, further comprising a docking means for receiving the wireless headset means, wherein the wireless headset means is automatically activated upon removal from the docking means and automatically deactivated when placed in the docking means.

26. An audio system comprising:
an audio source device comprising a first wireless communications module;
a loudspeaker system comprising:
an audio amplifier;
a loudspeaker for receiving an amplified audio signal from the audio amplifier; and
a second wireless communications module for receiving the audio signal from the first wireless communications module over a first wireless link;
a wireless headset comprising:
a headset speaker; and
a third wireless communications module for receiving the audio signal from the first wireless communications module over a second wireless link, wherein the audio source device routes the audio signal to the wireless headset upon activation of the wireless headset and routes the audio signal to the loudspeaker system upon deactivation of the wireless headset.

27. The audio system of claim 26, wherein the first wireless communications module, second wireless communications module, and third wireless communications module utilize a Bluetooth standard.

28. The audio system of claim 26, wherein the first wireless communications module, second wireless communications module, and third wireless communications module utilize an IEEE 802.11 or DECT standard.

29. The audio system of claim 26, further comprising:
a headset docking station for receiving the wireless headset, wherein the wireless headset is automatically activated upon removal from the headset docking station and automatically deactivated when placed in the headset docking station.

30. An audio system comprising:
a first audio source device;
a second audio source device comprising a first wireless communications module;
a wireless headset comprising a second wireless communications module; and
a loudspeaker system comprising
an audio amplifier for receiving an audio signal from the first audio source device;
a loudspeaker for receiving an amplified audio signal from the audio amplifier; and
a third wireless communications module, wherein the third wireless communications module receives a loudspeaker mute command from the second wireless communications module upon activation of the wireless headset and formation of a wireless link between the first wireless communications module and the second wireless communications module.

31. The audio system of claim 30, wherein the first wireless communications module, second wireless communications module, and third wireless communications module utilize a Bluetooth standard.

32. The audio system of claim 30, wherein the first wireless communications module, second wireless communications module, and third wireless communications module utilize an IEEE 802.11 or DECT standard.

33. The audio system of claim 30, further comprising:
a headset docking station for receiving the wireless headset, wherein the wireless headset is automatically activated upon removal from the headset docking station and automatically deactivated when placed in the headset docking station.
